(19) United States
(12) Patent Application Publication
(10) Pub. No.: US 2014/0112606 A1
(43) Pub. Date: Apr. 24, 2014

(54) ROLLER BEARING FOR WIND TURBINES

(71) Applicants: Ryan Greenfield, Vernon Hills, IL (US); Martin O'Shea, Charlotte, NC (US); Antonio Silverio, Danbury, CT (US); Daniel M. Brake, Hobe Sound, FL (US); Martin E. Lohan, Palm City, FL (US); Gregory John Smith, Port St. Lucie, FL (US)

(72) Inventors: Ryan Greenfield, Vernon Hills, IL (US); Martin O'Shea, Charlotte, NC (US); Antonio Silverio, Danbury, CT (US); Daniel M. Brake, Hobe Sound, FL (US); Martin E. Lohan, Palm City, FL (US); Gregory John Smith, Port St. Lucie, FL (US)

(21) Appl. No.: 14/056,352

(22) Filed: Oct. 17, 2013

Related U.S. Application Data
(60) Provisional application No. 61/715,701, filed on Oct. 18, 2012.

(51) Int. Cl. F16C 23/08

(52) U.S. Cl. CPC F16C 23/082
USPC 384/450

(57) ABSTRACT

A self aligning bearing assembly comprising a split inner ring and a split outer ring, and two rows of rolling elements arranged at different contact angles, for supporting a main shaft of a wind turbine.

### TECHNICAL FIELD

Example aspects described herein relate to bearing assemblies, particularly of self-aligning bearings for wind turbine applications.

### BACKGROUND

Bearing assemblies are typically circular in shape, and generally comprise rolling elements sandwiched between raceways in bearing rings. Rolling elements take many forms, including spherical balls, rollers or various other configurations, such as cone-shaped tapered rollers or barrel-shaped spherical rollers.

Bearings are widely used in wind power generation, particularly in the nacelle of the turbine, to support components in the gearbox and the main shaft of the wind turbine, which, typically the blade rotor assembly is mounted on. In large size wind turbines, the nacelle can be dozens of meters high above the ground, thus maintaining the bearings supporting the main shaft of the blade rotor assembly can involve substantial labor, costs and often the use of specialized equipment, such as large cranes.

Both radial and thrust loads are generated during power generation cycles in a wind turbine, as a result of the action of the wind on the blade rotors and, in turn, the main shaft. The main shaft bearing, must, therefore, be able to support both radial and axial (or thrust) loads.

Various bearing assemblies are disclosed for rotatably supporting the main shaft of the wind turbine, for example, U.S. Pat. No. 7,918,649 discloses a double row spherical roller assembly with one row having rollers of different lengths from every roller of the other row. A disadvantage of such assemblies is that an entire bearing assembly must be lifted and mounted in place on the main shaft of the wind turbine.

### SUMMARY OF THE INVENTION

A new design for a bearing assembly for a wind turbine is disclosed. In one example embodiment of the invention, the bearing comprises two rows of rolling elements disposed between an axially split inner ring and an axially split outer ring, the rolling elements retained by a cage.

### BRIEF DESCRIPTION OF DRAWINGS

The above mentioned and other features and advantages of the embodiments described herein, and the manner of attaining them, will become apparent and be better understood by reference to the following description of at least one example embodiment in conjunction with the accompanying drawings. A brief description of those drawings now follows.

FIG. 1 is a cross sectional view of a bearing assembly according to one example embodiment herein described.

### DETAILED DESCRIPTION OF THE INVENTION

Identically labeled elements appearing in different ones of the figures refer to the same elements but may not be referenced in the description for all figures. The exemplification set out herein illustrates at least one embodiment, in at least one form, and such exemplification is not to be construed as limiting the scope of the claims in any manner. Radially inward directions are from an outer radial surface of the cage, toward the central axis or radial center of the cage. Conversely, a radial outward direction indicates the direction from the central axis or radial center of the cage toward the outer surface. Axially refers to directions along a diametric central axis.

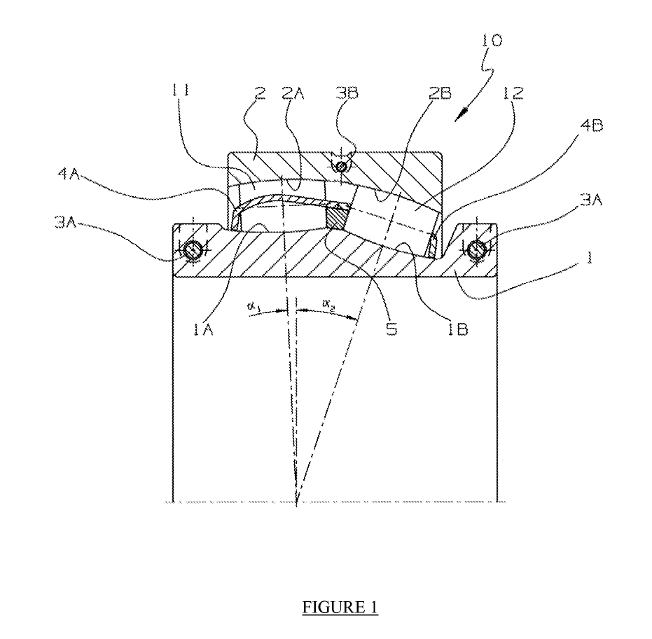

FIG. 1 is a cross sectional view of bearing assembly 10 according to one example embodiment of the invention. Bearing assembly 10 comprises split inner ring 1 having inner races 1A and 1B, split outer ring 2 having outer races 2A and 2B, first row rolling elements 11 disposed in cage 4A , second row rolling elements 12 disposed in cage 4B, each row, 11 and 12, separated by floating spacer 5. Floating spacer 5 may be inner ring or outer ring guided. Rolling elements 11 and 12 are shown as spherical rollers, however, the present invention contemplates the use of other rolling elements. In addition, rolling elements 11 and 12 are shown as of equal length, though different length rollers are also contemplated by the present invention.

Split inner ring 1 comprises two circumferential sections or segments 13 and 14 joined by joining bolts 3A, forming a continuous ring when joined. Split outer ring 2 comprises two circumferential sections 15 and 16 joined by joining bolt 3B, forming a continuous ring when joined. When split inner ring 1 and split outer ring 2 are assembled, races 1A, 1B, 2A and 2B form smooth, continuous races for rolling elements 11 and 12, respectively.

In one example embodiment, first row rolling elements 11 operate at contact angle al and second row rolling elements operate at contact angle α2, where α1 and α2 are different from each other. In the embodiment shown at FIG. 1, α2 is greater than α1, and therefore, second row rolling elements 12 are better accommodated to support increased thrust loads, for example, from a wind turbine rotor. In this configuration, first row rolling elements 11 would be mounted toward the rotor blades (not shown) of the wind turbine and second row rolling elements would be mounted toward the gearbox side (not shown) of the wind turbine.

In the foregoing description, example embodiments are described. The specification and drawings are accordingly to be regarded in an illustrative rather than in a restrictive sense. It will, however, be evident that various modifications and changes may be made thereto, without departing from the broader spirit and scope of the present invention.

In addition, it should be understood that the figures illustrated in the attachments, which highlight the functionality and advantages of the example embodiments, are presented for example purposes only. The architecture or construction of example embodiments described herein is sufficiently flexible and configurable, such that it may be utilized (and navigated) in ways other than that shown in the accompanying figures.

Although example embodiments have been described herein, many additional modifications and variations would be apparent to those skilled in the art. It is therefore to be understood that this invention may be practiced otherwise than as specifically described. Thus, the present example embodiments should be considered in all respects as illustrative and not restrictive.

### LIST OF REFERENCE SYMBOLS

1 Split Inner Ring
1A First Row Inner Race
1B Second Row Inner Race
2 Split Outer Ring
2A First Row Outer Race
2B Second Row Outer Race
3 Joining Bolts
3A Inner Ring Joining Bolts
3B Outer Ring Joining Bolts
4A First Row Cage
4B Second Row Cage
5 Floating Spacer
10 Bearing Assembly
11 First Row Rolling Elements
12 Second Row Rolling Elements
13 Split Inner Ring First Section
14 Split Inner Ring Second Section
15 Split Outer Ring First Section
16 Split Outer Ring Second Section

What we claim is:

1. A bearing assembly for supporting a main shaft of a wind turbine comprising:
a split outer ring comprising;
a first section having a bearing raceway on an inner radial surface;
a second section having a bearing raceway on an inner radial surface; and
a plurality of fasteners joining the first and second sections such that a continuous bearing raceway is formed from the first and second section bearing raceways;
a split inner ring comprising;
a first section having a bearing raceway on an outer radial surface;
a second section having a bearing raceway on an outer radial surface; and
a plurality of fasteners joining the first and second sections such that a continuous bearing raceway is formed from the first and second section bearing raceways;
a first row of rolling elements retained by a first cage;
a second row of rolling elements retained by a second cage;
all of the first row of rolling elements having the same length as all of the second row of rolling elements; and
the first row of rolling elements arranged at a different contact angle from the second row of rolling elements

2. The bearing assembly of claim 1, wherein the second row of rolling elements has a greater contact angle than the first row of rolling elements.

3. The bearing assembly of claim 2, wherein the second row of rolling elements is arranged remote from the blade rotor.

4. The bearing assembly of claim 1, wherein the first row of rolling elements and the second row of rolling elements are separated by a floating spacer.
